(19) United States
(12) Patent Application Publication
(10) Pub. No.: US 2012/0331471 A1
(43) Pub. Date: Dec. 27, 2012

(54) EXECUTING MOLECULAR TRANSACTIONS

(75) Inventors: Ganesan Ramalingam, Bangalore (IN); Kapil Vaswani, Bangalore (IN)

(73) Assignee: MICROSOFT CORPORATION, Redmond, WA (US)

(21) Appl. No.: 13/169,060

(22) Filed: Jun. 27, 2011

(51) Int. Cl. G06F 9/46

(52) U.S. Cl. 718/102

(57) ABSTRACT

The claimed subject matter provides a method for executing molecular transactions on a distributed platform. The method includes generating a first unique identifier for executing a molecular transaction. The molecular transaction includes a first atomic action. The method further includes persisting a first work list record. The first work list record includes the first unique identifier and a step number for the first atomic action. Additionally, the method includes retrieving, by a first worker process of a runtime, the first work list record. The method also includes executing, by the first worker process, the first atomic action in response to determining that a first successful completion record for the first atomic action does not exist. Further, the method includes persisting, by the first worker process, the first successful completion record for the first atomic action in response to a successful execution of the first atomic action.

### BACKGROUND

Distributed platforms consist of sets of nodes, in communication with each other to perform computational operations, such as bank transactions conducted online. Individual nodes of distributed platforms store data, perform computational operations, etc. In these platforms, computational operations are typically performed in sequences. For example, a request transfer funds between bank accounts may be accomplished via a sequence of distributed operations. A first operation may debit the account from which funds are transferred. A second operation may credit the transferred-to account. Such platforms are fault-tolerant, meaning they are configured to perform in light of node, commmunication, or other operational failures. As such, distributed operations are typically executed pass-fail. In other words, if any of a sequence of distributed operations fails, then none of the operations is to be successfully performed. For example, if the credit operation fails, the debit operation is undone, meaning the debited funds are credited back. Another issue, due to redundancies of such platforms, arises in ensuring that distributed operations are executed only once. In platforms that do not support distributed transactions, programmers manually code program logic to achieve these desired properties.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The claimed subject matter provides a method for executing molecular transactions on a distributed platform. The method includes generating a first unique identifier for executing a molecular transaction. The molecular transaction includes a first atomic action. The method further includes persisting a first work list record. The first work list record includes the first unique identifier and a step number for the first atomic action. Additionally, the method includes retrieving, by a first worker process of a runtime, the first work list record. The method also includes executing, by the first worker process, the first atomic action in response to determining that a first successful completion record for the first atomic action does not exist. Further, the method includes persisting, by the first worker process, the first successful completion record for the first atomic action in response to a successful execution of the first atomic action.

Additionally, the claimed subject matter provides a system for executing molecular transactions on a distributed platform. The system may include a processing unit and a system memory. The system memory may include code configured to direct the processing unit to generate a first unique identifier for an execution of a molecular transaction that includes a first atomic action. A first work list record may be persisted that specifies the first unique identifier and a step number for the first atomic action. The first work list record is retrieved. The first atomic action is executed in response to a determination that a first successful completion record for the first atomic action does not exist. It is determined that a first worker process has failed to successfully execute the first atomic action. The first worker process is replaced with a replacement worker process.

Further, the claimed subject matter provides one or more computer-readable storage media. The computer-readable storage media may include code configured to direct a processing unit to execute a molecular transaction. A first unique identifier is generated for an execution of a molecular transaction that includes a first atomic action and a second atomic action. The molecular transaction specifies that the second atomic action is executed subsequently to the first atomic action. A first work list record is persisted that specifies the first unique identifier and a step number for the first atomic action. The first work list record is retrieved. The first atomic action is executed in response to a determination that a first successful completion record for the first atomic action does not exist. The first successful completion record for the first atomic action is persisted in response to a successful execution of the first atomic action. A second work list record is persisted that specifies the unique identifier and a step number for the second atomic action. The second work list record is retrieved. The second atomic action is executed in response to a determination that a successful completion record for the second atomic action does not exist. The molecular transaction is aborted during execution of the second atomic action. The molecular transaction includes a first compensation action corresponding to the first atomic action. A second successful completion record for the second atomic action is persisted such that the second successful completion record includes a status indicating the molecular transaction is aborting. A third work list record is persisted that specifies the unique identifier and a step number for the first compensation action.

### BRIEF DESCRIPTION OF THE DRAWINGS

FIG. 1 is a block diagram of a system in accordance with the claimed subject matter;

FIG. 2 is a diagram illustrating operational syntax of a λ_{MT} implementation, in accordance with an embodiment of the claimed subject matter;

FIG. 3 is a process flow diagram of a method for executing a molecular transaction on a distributed platform, in accordance with the claimed subject matter;

FIG. 4 is a process flow diagram of a method for executing a molecular transaction on a distributed platform, in accordance with the claimed subject matter;

FIG. 5 is a block diagram of an exemplary networking environment wherein aspects of the claimed subject matter can be employed; and

FIG. 6 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, the terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

### Introduction

Building distributed applications that scale seamlessly with load often requires adopting idioms such as data partitioning, and structuring computation into loosely coupled services. While these practices achieve scale, they expose programmers to the pitfalls of distribution such as system failures and management of distributed state. In an embodiment, a new programming abstraction using molecular transactions simplifies programming scalable distributed systems. A molecular transaction is a fault tolerant composition of conventional ACID transactions with user-defined compensating actions. ACID transactions are database implementations that ensure data consistency in light of transactions that abort, or otherwise terminate in error. An implementation of this construct may be used on a platform for hosting internet scale services. Molecular transactions enable programmers to focus on business logic, rather than low-level details, leading to more declarative, and readable, applications. Advantageously, programmers are also freed from writing lots of tedious code.

The ability to scale with large workloads and survive failures is useful in web applications, for example. Applications often meet these goals by employing design patterns, such as data partitioning. Data-partitioning is used to achieve a scalable database layer, for fault tolerance, and for applications that take the form of loosely coupled services. These basic principles are employed in the design of modern programming platforms such as Windows Azure™, Amazon EC2® and Google App Engine™. These platforms provide scalable storage systems that allow data to be organized into partitions. Partitions are dynamically distributed across many storage nodes for load balancing and replicated for fault tolerance. Similarly, computation is modelled as a set of services that may be replicated for scaling. The services are supported by a runtime that can detect failures, and automatically restart services when they fail.

An embodiment includes programming abstractions that make it simpler to build this class of applications by automating certain tedious details. These abstractions tackle challenges in correctly threading control-flow through a computation in these applications. The first challenge arises because of the possibility of compute-node failures. In the event of such failures, complex progam logic is used to ensure that a failed computation can be resumed at the right point and in the right state. The second challenge arises in encoding a widely-used idiom for composing loosely coupled services. According to this idiom, a logical failure at a later stage in a pipeline of actions triggers compensation actions. The compensation actions are performed to undo actions performed earlier in the pipeline. This idiom is an alternative to distributed transactions that is widely used in practice, either because distributed transactions are simply not available or too expensive to use.

While the abovementioned platforms hide certain kinds of failures, such as storage-node failure, from the developer, they may expose compute-node failures. Hiding in this context means that the platform takes care of certain failures instead of the programmer. In contrast, when compute-node failures are exposed, the programmer writes code to handle such failures. The platforms provide a default mechanism for detecting failures, and restarting compute-nodes. While this partially enables fault-tolerance, it is not usually sufficient because the local state of the node is lost. Typically, stateless applications are built for these platforms such that they recover from such failures. One approach, idempotence, gives a transaction the quality that—regardless how many times it is executed—the end result appears as though the transaction only executes once.

An example platform for a bank may partition account information based on the branch where the account is opened. Accordingly, in the storage system, an operation to transfer funds from an account in one branch to an account in another branch, is typically performed in two separate local transactions: a debit transaction against one account, then a credit transaction against the other. One challenge in writing the source code that performs these transactions in to make the transactions tolerate compute node failures. Checkpointing, a conceptually simple approach, is, in practice, manually tedious and error-prone.

Another challenge is that even if an application is designed to tolerate compute node faults, it may still encounter logical failures due to the partitioning of transactions. For example, consider the fund transfer scenario, implemented as described above. The debit transaction may succeed; however, the credit transaction may fail. The reason for the failure may not be related to a compute node failure. Rather, there could be an issue with account numbers, etc. In this scenario, a logical failure has occurred. This is problematic because, for the transfer transaction to properly complete, either both the credit and debit transactions succeed, or neither appear to have happened at all. One way of recovering from this failure is to undo the debit by crediting the amount back to the source account. These application-specific compensating actions and associated recovery logic are a significant source of programming complexity.

An embodiment of molecular transactions addresses both of these challenges. According to the subject innovation, programmers may be provided with a way to construct fault-tolerant computations by composing together atomic actions. Programmers may be further provided a way to schedule a fault-tolerant computation for execution. This may include an implementation mechanism and a runtime. Additionally, the subject innovation may provide programmers with the following ways to construct molecular transactions: combining atomic action with corresponding compensating actions, and composing two or more molecular transactions together. Further, programmers may be provided with a way to schedule a molecular transaction for execution.

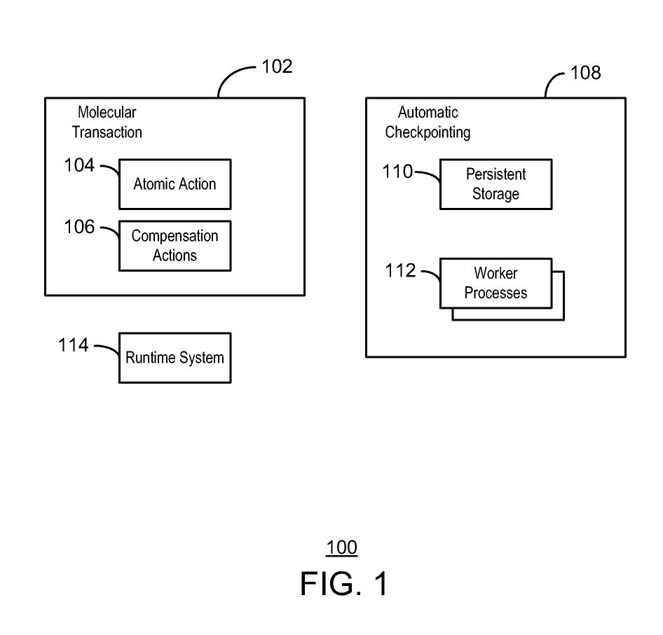

FIG. 1 is a block diagram of a system 100 in accordance with the claimed subject matter. The system 100 includes molecular transactions 102, which include atomic actions 104 and compensation actions 106. The system 100 also includes a mechanism for automatic checkpointing 108, which includes persistent storage 110, and worker processes 112. Additionally, the system 100 includes a runtime system 114.

The molecular transaction 102 is a fault-tolerant, all-or-nothing composition of atomic actions 104. For example, the molecular transaction 102 may be a composition of atomic actions {a₁; . . . ; aₖ}. According to this composition, if aᵢ successfully commits, then aᵢ₊₁ will be eventually evaluated, even if the compute-node evaluating the molecular transaction 102 fails. Atomic actions 104 are also referred to herein as operations. Further, the atomic actions 104 may be undo-able. Undo-able means that the effect of each atomic action 104 may be undone by a corresponding compensation action 106. As such, in the case of a logical failure, the programmer can direct the molecular transaction 102 to abort. In the case of an abort, the transaction is not to be committed. Instead, the atomic actions completed up until the abort are accordingly undone by the corresponding compensation actions 106. In one embodiment, the compensating actions are performed in reverse order of the previously executed actions.

Molecular transactions 102 may be implemented in programming languages, such as F#. The programming language F# targets the .NET platform and supports both functional and object oriented programming paradigms. An example of the molecular transaction 102 written in F# is shown in Source Code 1:

SOURCE CODE 1

```
let credit toAccount amount = atomic {
    let! accDetails = readAtomic ”accounttable” toAccount
    match accDetails with
    | None →abort
    | Some(accDetails)→
    let newaccDetails = accDetails.Credit(amount)
    return! writeAtomic ”accounttable” toAccount newaccDetails }
let debit fromAccount amount = atomic {
    let! accDetails = readAtomic ”accounttable” fromAccount
    match accDetails with
    | None→abort
    | Some(accDetails)→
    if accDetails.Balance < 0 then abort
    else
        let newaccDetails = accDetails.Debit(amount)
        return! writeAtomic ”accounttable”
        fromAccount newaccDetails }
let branchtransfer to from amount = molecule {
    do!
        debit from amount
        |> compensateWith <|
        fun ( )→credit from amount
    return!
        credit to amount
        |> compensateWith <|
        fun ( )→debit to amount
}
```

The let! and do! commands are special F# constructs that override normal binding and delegate binding to the enclosing monad's bind. The return! command translates to a call to the monad's return operation and is used to construct values of monadic type from primitive types. The return! is used with other operations that construct monadic values. As shown, the Source Code 1 includes atomic actions 104, debit and credit. For the purpose of discussing Source Code 1, account information is stored in a table called “accounttable,” partitioned by branch. The credit and debit actions read and update individual account details from the accounttable. An atomic construct may be used to wrap expressions that are evaluated atomically. Another construct called abort, may be used in atomic transactions in cases of logical failures. For example, debit aborts if the balance is insufficient. As such, the credit action may be undone with a compensating action. Additionally, either of the debit or credit actions may abort if the account information is not available.

The Source Code 1 also includes branchtransfer, expressed using a molecule construct. This molecular transaction 102, branchtransfer, composes the two atomic actions 104, credit and debit. Further, in branchtransfer, each atomic action 104 is associated with a compensating action that is specified using the construct, compensateWith. Configured in this way, the molecular transaction 102, branchtransfer, is tolerant to compute node failures, and uses all-or-nothing semantics in case of logical failures. Advantageously, these features, along with better scalability, may be achieved with little increase in programming complexity. Apart from the specification of compensating actions, the branchtransfer transaction is not very different from sequential code typically used for such transactions. Advantageously, the molecule construct enables the use of language features, such as local variables, try-catch blocks, etc., across atomic actions 104 in the same molecular transaction 102. This advantage may be provided even in scenarios where different atomic actions 104 execute on different compute nodes.

In one embodiment, every atomic action 104 within the molecular transaction 102 may appear to execute exactly-once using the automatic checkpointing 108. In such an embodiment, the programmer writes the molecular transaction 102 without addressing the possibility of node failures, which are handled automatically. A persistent storage 110 may include a worklist of operations to be performed. The worklist may be a persistent queue. The persistent storage 110 may also keep track of the status of the molecular transaction's execution. Whenever the molecular transaction 102 performs an operation that may read or write persistent data, the operation status may be updated by a worker process 112. A set of worker processes 112 may read and execute the operations specified in the worklist. The worker processes 112 may be initially created by the runtime system 114. The worker processes 112 may continue running unless there is a compute-node failure. If there is a compute-node failure, the runtime system 114 may detect the failure, and replace the failed worker process 112 with a new worker process.

In another embodiment, the programmer may be provided with a construct for composing any action with a corresponding compensating action. The programmer may also be provided with a construct for sequentially composing atomic actions 104 into a molecular transaction 102. Further, within the atomic actions 104, the programmer may invoke an abort function during the molecular transaction's execution. The embodiment takes care of ensuring that the atomic actions 104 all execute in sequence exactly once. If any atomic action 104 aborts, compensating actions corresponding to the atomic actions 104 already executed, are performed in the appropriate sequence to undo the completed atomic actions 104.

### A Fault Tolerant Programming Language

A simple language, λ_{MT}, based on lambda calculus, may be provided, to formalize the semantics of molecular transactions 102. The language λ_{MT} includes a construct, eₐe_{c}, that pairs an undo-able atomic action, eₐ, with its compensating action e_{c}. Further, the language λ_{MT} includes a construct, molecule e, to specify an all-or-nothing composition of undo-able atomic actions 104. Another construct, abort, is used to abort an atomic action 104, which also aborts the molecular transaction 102 that contains the aborted atomic action 104. In a language where failure is possible, molecular transactions 102 enable fault-tolerant all-or-nothing composition.

The ideas illustrated in the simplified settings of λ_{MT} may be incorporated in molecular transactions 102 for the programming language F#. Molecular transactions 102 may be added to F# using F#'s support for monads. Monads are a functional programming abstraction that can be used to give new semantics to computations, and define how computations compose. A monad consists of a generic type M<′a> and two operations, return and bind, which satisfy the monad laws. A failure-free composition of actions can be achieved with a monad that internally uses checkpointing. Additionally, an all-or-nothing composition of undo-able actions can be achieved using a monad. Monads are further described in, Expert F# (Expert's Voice in .NET), ISBN (9781590598504), by Don Syme, et al. (2007), the contents of which are hereby incorporated by reference in their entirety.

The molecular transaction 102 may be implemented in various programming languages. To demonstrate a generic implementation, generic programming language is presented. This generic programming language is based on lambda calculus, and referred to herein as λ_{FAULT}. A definition is provided for a fault-tolerant program that is tolerant of computer-node failures and restarts. Such failures are further formalized in the semantics of λ_{fault}. Using these semantics, fault-tolerance may be enabled via checkpointing. A language construct is provided for coding fault-tolerant programs. In one embodiment, a program in the λ_{FAULT} language represents a service. The program may receive requests over an input queue, and send responses back over an output queue. A program consists of a set of threads that share persistent data in the form of a table. Threads are also referred to herein as executing agents, e.g., the worker processes 112. For simplicity, the embodiment is described with reference to only a single input queue, a single output queue, and a single persistent table, all of which are unnamed. However, depending on the details of a particular implementation multiple queues and tables may be used.

Using the λ_{FAULT} language, an agent executes some code, and maintains an internal state. The internal state may be represented by local variables specified in code executed by the agent. It is understoond that the agent may fail at any time. The failure is not necessarily a failure of the agent attempting to execute code. Some failures may be caused by the environment. A power source may fail, there may be hardware failures, an operating system may force termination of the program, etc. When the agent fails, the agent's failure may be detected by the runtime system. The λ_{FAULT} provides an operational semantics to capture failures, and to replace the failing agent with a new agent. With the new agent, the failure, i.e., fault, may be tolerated, and the program may be brought to a successful termination. Successful termination means an all or nothing completion of the molecular transaction 102.

After a failure, typically any information in the internal state of the failed agent is lost. The new agent starts executing code from the beginning with its own internal state. While the internal state of the failed agent is lost, persistent data is typically not lost. Persistent data is typically stored in tables. In contrast, transient data stored in the local variables of agents may be lost as a result of agent failures.

In programming languages, various language elements describe computations performed by agents. The language λ_{FAULT} consists of lambda calculus extended with primitive constructs for dealing with tables and queues, as explained below. The primitives include peek, dequeue, and enqueue. The peek primitive is used for reading the next message in a queue.

The queue primitives are somewhat non-standard because the λ_{FAULT} language is configured to handle agent failures. However, it is understood that typical programming languages may be similarly configured to handle agent failures in accordance with the claimed subject matter. The dequeue primitive removes a message from a queue. The enqueue primitive adds a new message to a queue. When an agent, peeks at a message in a queue, the queue temporarily removes the message from the queue, and sets it aside. In other words, the queue implementation does not return the same message to some other agent who peeks at the queue later. Normally, a dequeue operation removes the first message from the queue and returns it. However, in one embodiment, the returned message may not be permanently removed from the queue. It may only be temporarily removed, and stored in some other data structure. Once the agent has successfully processed the message, the agent may invoke the dequeue primitive to permanently remove the message from the queue. In one embodiment, the peek primitive may return a unique id with every peeked message. The dequeue primitive may use this unique id to specify the message to be dequeued. If the agent does not explicitly dequeue the message from the queue, the message moves back to the queue, and is read again when any agent subsequently peeks at the queue. In this way, if the agent fails before processing the message m, the replacing agent may re-read the queue and process the message accordingly. Simple primitives are also provided for adding and removing tuples from a table, such as a table storing persistent data.

The syntax of λ_{FAULT} is represented in Meta Code 1:

$$\begin{matrix}〈 Program 〉 & :: = & {e}_{1} ‖ … ‖ {e}_{n} \\ e ∈ 〈 Expr 〉 & :: = & c \vert x \vert λ x \cdot e \vert ee \vert ( e , e ) \\ & \vert & if e then e else e \\ & \vert & peek \vert dequeue e \vert enqueue e \\ & \vert & add e \vert remove e \\ v ∈ 〈 Val 〉 & = & c \vert λ x \cdot e \vert ( v , v ) \\ \begin{matrix}3 cx ∈ 〈 Identifier 〉 , \\ c ∈ 〈 Constant 〉\end{matrix} & & \end{matrix} \qquad META CODE 1$$

As shown, a program in λ_{FAULT} is represented as e₁∥ . . . ∥eₙ, where eᵢ represents each agent.

### Programming Fault Tolerance

Fault-tolerant programs are typically written using some form of checkpointing. During program execution, at specified check points, information about the program's current state may be saved to the persistent storage 110, which may be a database table. Subsequently, when the program re-starts, or a new agent begins execution, any checkpointed information may be looked up. If checkpointed information is found, execution may be resumed at the appropriate state. Otherwise, execution may begin from the initial state.

While checkpointing is conceptually straightforward, it is tedious to implement and significantly error-prone because, to avoid checkpointing failures, the programmer codes specifically for a number of corner cases. In an example scenario, an agent may make a persistent change, such as adding or removing an item from a table. However, before the agent makes a checkpoint, the operation may fail. Such a scenario represents a corner case. Errors may also arise if the programmer fails to capture the complete state when checkpointing. More complications arise when programmers attempt to checkpoint for every operation with a side-effect. In embodiments of the claimed subject matter, having primitive support from the underlying programming language, or operating system, may improve the efficiency of fault-tolerant programming. For example, the ability to atomically combine a queue operation with a table operation may improve this efficiency. Given these challenges, automating fault tolerance by augmenting the language, or via a library, is useful.

In one embodiment, the λ_{FAULT} language may include a construct referred to herein as failfree. In such an embodiment, the construction, failfree e, may indicate that expression e is evaluated as if no failure occurred during the evaluation. Such an embodiment may also guarantee fault-tolerance for the whole program. The failfree construct enables programmers to specify the code fragment for which they desire fault tolerance. This enables programmers to use other methods to ensure fault tolerance elsewhere. Such methods may be program-specific. Certain distributed, and partitioned, platforms provide certain operations that allow for the addition or removal of sets of tuples from persistent storage. These operations may be restricted to acting on tuples in the same partition. The failfree construct may be viewed as a more general form of these operations.

### Molecular Transactions

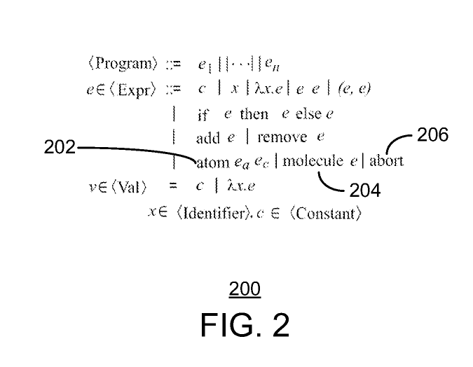

Other challenges in writing distributed applications arise in dealing with interference between concurrent agents, ensuring data consistency, and handling logical failures. In one embodiment of the claimed subject matter, molecular transactions 102 are provided as a language construct of another simple language, referred to herein as λ_{MT}. FIG. 2 is a diagram illustrating operational syntax of a λ_{MT} implementation, in accordance with an embodiment of the claimed subject matter. The syntax of λ_{MT} consists of lambda calculus extended by the constructs shown in FIG. 2.

An atom 202 specifies an atomic action eₐ and a corresponding compensation action, e_{c}. The compensation action, e_{c}, is performed in case the molecular transaction 102 aborts. The atom 202 indicates that eₐ is evaluated atomically, i.e., without interference from other concurrent computations. The molecule 204 indicates that eₘ is evaluated as a molecular transaction. The abort 206 indicates that the current transaction terminates. The language, λ_{MT} also includes the operations, add and remove, for updating a persistent table. The molecular transaction 102 may be a λ_{MT} program consisting of a set of expressions, e.g., agents, evaluated concurrently.

### Implementation

Molecular transactions 102 may be implemented on platforms that include a variety of compute and storage services. These services may include relational databases, and rich sets of scalable, non-relational data abstractions, such as tables, blobs, queues, etc. Typically, tables are key-value stores that explicitly support data partitioning, which allows the tables to handle large amounts of data. Each key-value pair, also referred to herein as an entity, is associated with a partition key. Entities with the same partition key are guaranteed to be co-located on the same data partition.

The scope of ACID transactions is restricted to entities within the same data partition. Distributed transactions that span partitions are not supported because of their performance implications. Programmers typically select a data partitioning strategy to ensure that entities that are accessed within the same transaction belong to the same table and the same data partition. At the same time, partitioning schemes are configured to distribute work, and avoid creating hotspots. Hotspots are very large partitions that serve a disproportionate number of accesses. Molecular transactions 102 are useful in such storage systems because molecular transactions 102 provide a way for reliably composing atomic transactions, where each transaction operates on one data partition.

As stated previously, one embodiment of molecular transactions 102 was implemented in the F# programming language. Like conventional transactions, molecular transactions 102 can be expressed using F#'s monads. Monads are a functional programming abstraction that can be used to give new semantics to computations, and define how computations are composed. The typical use of monads is to sequence computations with effects. A monad typically consists of a generic type M<′a> and two operations, return and bind. The return and bind operations are shown in Source Code 2:

SOURCE CODE 2

return : ′a → M< ′a >
bind : M< ′a > → ( ′a → M< ′b > ) → M< ′b >

The F# implementation of molecular transactions 102 is a composition of two monads: a failfree monad and an all-or-nothing monad. The failfee monad, shown in Source Code 3, ensures fault tolerance for agent failures between atomic transactions.

SOURCE CODE 3

```
type TC = int
type Queue = string
type Failfree < ′a > = (( ′a → unit) * System.Guid * TC ) → unit
queue : Queue → ′a → unit
peek : Queue → ′a option
dequeue : Queue * ′a → unit
serialize : ′a → string
deserialize : string → ′a
gettable : Atomic< ′a > → Table
let toFailfree (a : Atomic< ′a > ) : Failfree < ′a > =
    fun (f, guid , tc ) →
        let table = gettable a
        let key = concat(guid, pc)
        let b = atomic {
            let! val = readAtomic table key
            match val with
            | Some(v) → return v
            | None →
                let! v = a
                do! addAtomic table key v
                return v }
        f ( runAtomic b)
let return (a : ′a) : Failfree < ′a > =
    fun (f, guid, tc ) → f a
let bind (v : Failfree < ′a > ,f : ′a → Failfree < ′b > ) =
    fun (g, guid , tc ) →
        let h = fun (a) → queue “checkpointq” (f, a, guid , tc + l, g)
        v h guid tc
let agent ( ) =
    while (true)
    let msg = peek “checkpointq”
    match deserialize msg with
    Some(f, a, guid , tc , g) →
        do f a g guid tc
        dequeue “checkpointq” msg
    | None → ( )
    let runCheckpoint (c : Failfree < ′a > ) =
        c (System.Guid.NewGuid ( ), 0, fun (x) → ( ) )
```

The all-or-nothing monad, shown in Source Code 4, provides an explicit abort operation, and structures control flow to evaluate user-defined compensating actions if a molecular transaction 102 aborts.

SOURCE CODE 4

```
type AtomicVal< ′a > =
  | Value of ′a
  | Abort
let abort = fun (f) → Abort
type AllOrNothing< ′a , ′b > = ( ′a → AtomicVal< ′b > ) →
AtomicVal< ′b >
let return (a : ′a ) = fun (f) → f a
let bind (v : AllOrNothing< ′a , ′b > , f : ′a → AllOrNothing< ′c ,
  ′b > ) = fun (g) → v ( fun (a) → f a g)
let toAllOrNothing(a : Atomic< ′a > ) =
  fun (f) →
    match runAtomic a with
    | Abort → Abort
    | Value(b) → f b
let compensateWith(body : Atomic< ′a > )(comp : ′a →
  Atomic<unit> ) = fun (f) →
    match runAtomic body with
    | Abort → Abort
    | Value(b) →
      match f b with
      | Abort →
        do runAtomic comp b
        Abort
      | Value(c) → Value(c)
let runAllOrNothing (a : AllOrNothing< ′a , ′b > ) =
  a( fun (x) → Value(x))
```

Atomic transactions are also expressed using a monad. Source Code 5 shows the interface of the atomic transaction monad.

SOURCE CODE 5

type Atomic< ′a > = unit → ′a
type Table = string
type Key = string
return : ′a → Atomic< ′a >
bind : Atomic< ′a > → ( ′a → Atomic< ′b > ) → Atomic< ′b >
addAtomic : Table → Key → ′a → Atomic<unit>
readAtomic : Table → Key → Atomic< ′a option>
writeAtomic : Table → Key → ′a → Atomic<unit>
deleteAtomic : Table → Key → Atomic<unit>
runAtomic : : Atomic< ′a > → ′a

The persistent storage 110 may include a store modeled as a set of key-value pairs. An atomic transaction is a computation that evaluates atomically and returns a primitive value. The operations, addAtomic, readAtomic, writeAtomic, and deleteAtomic are variants of standard CRUD operations that construct monadic values. The readAtomic operation returns a value only if the specified key exists. Otherwise, a special value, “None,” is returned. The runAtomic operation runs the atomic transaction. For the sake of simplicity, this description assumes that the runAtomic operation guarantees ACID semantics as long as each transaction accesses a single table. It is further assumed that all transactions in programs that use this monad access a single table. In one embodiment, the runAtomic operation guarantees ACID semantics only for transactions that access the same table and partition. Otherwise, an exception is thrown. The atomic transaction monad allows expressions to be enclosed in an atomic block as shown in Source Code 1.

In one embodiment, molecular transactions 102 use a checkpointing mechanism to guarantee fault tolerance against failures between atomic transactions. Advantageously, this checkpointing mechanism may be used for distributed and non-distributed transactions. The mechanism relies on the availability of persistent queues, a data structure designed to support fault tolerant communication between agents in distributed systems. Persistent queues typically support three operations: queue, peek, and dequeue. The semantics of the operations are typically configured to guarantee at-least once delivery of messages. In the embodiment, each agent peeks a checkpoint from the persistent queue, evaluates the next atomic transaction, queues a checkpoint representing the rest of the molecular transaction 102, and dequeues the incoming checkpoint. The semantics of the queue ensure that each message is processed at least one, even if agents fail before dequeuing the message containing a checkpoint. However, under these semantics, the same atomic transaction may be evaluated more than once by different agents. Accordingly, the atomic transactions may be idempotent to satisfy the semantics of molecular transaction 102.

Exactly-once semantics for molecular transactions 102 may be guaranteed by configuring atomic transactions to make them idempotent. In one embodiment, a globally unique identifier is assigned to every molecular transaction 102, and to every atomic transaction within a molecular transaction 102. The identifier for an atomic transaction is a combination of the molecular transaction's identifier and a counter that tracks the number of atomic transactions in the current molecular transaction 102. Given a non-idempotent atomic transaction that accesses a table t, the transaction may be configured to add an entity to t with its unique identifier as the key. Further, the value computed by the transaction may be the entity value, as shown in the toFailfree operation shown in Source Code 3. The transaction may also be configured to check if this entity already exists in the persistent storage 110. If the entity exists, the transaction has already been committed, and the value is returned. Otherwise, the atomic transaction is run.

The checkpointing mechanism may be expressed as a monad, as shown in Source Code 3. A failfree computation represented by the type Failfree <′a> encapsulates an atomic transaction of type Atomic<′a>. Given a continuation representing the rest of the computation, a unique identifier for the molecular transaction 102 and the current atomic transaction, the failfree computation executes and commits the encapsulated transaction, checkpoints the continuation to a queue, and returns. The monadic bind invokes a failfree computation with a continuation, which in turn serializes the rest of the molecular transaction 102. The auxiliary operation toFailfree converts an atomic transaction to a failfree computation. The operations queue, peek, and dequeue are standard persistent queue operations. The monad provides two operations: serialize and deserialize for, respectively, serializing and de-serializing types, including closures. Checkpointing agents (represented by the agent operation) de-serialize messages read from the queue, invoke the rest of the molecular transaction 102, and dequeue messages.

Source Code 6 illustrates the use of the failfree monad to guarantee fault tolerance for an account transfer operation. The function toFailfree lifts the atomic credit and debit operations to monadic types. This may ensure that these operations execute in a failfree manner. Such an implementation guarantees that if the debit action succeeds, the credit action is eventually performed, even if the node performing the transfer fails.

SOURCE CODE 6

```
  let transfer to from amount = failfree {
  do! toFailfree (debit from amount)
  return! toFailfree (credit to amount)
}
```

In the event of a logical failure, all-or-nothing semantics may also be guaranteed. Under these semantics, each atomic transaction in a molecular transaction 102 is optionally associated with a compensating action. If an atomic transaction experiences a logical failure, compensating actions of previously committed atomic transactions are evaluated. In one embodiment, the compensating actions may be perfomed in reverse order of their corresponding atomic transactions. The all-nothing composition may be implemented using a monad. First, the atomic transaction monad may be extended with an explicit abort operation that is used to indicate a logical failure. The atomic transaction monad may also be redefined as a computation that can either return a primitive value or a special value, such as “Abort.”

An all-or-nothing computation represented by the type AllOrNothing <′a, ′b> in Source Code 4, encapsulates an atomic transaction of type Atomic<′a>, and potentially, a compensation action 106 of type ′a→Atomic<unit>. The operation toAllOrNothing lifts an atomic transaction to an all-or-nothing computation. The operation compensateWith constructs an all-or-nothing computation from an atomic transaction and its compensating action.

Given a continuation, f, representing the rest of the molecular transaction 102, the all-or-nothing computation first evaluates the atomic transaction. If the transaction aborts, the whole computation aborts and return a special value, “Abort.” If the transaction commits successfully, the continuation is evaluated. If the continuation aborts because one of the subsequent atomic transactions aborts, the compensating action is evaluate, and the Abort value is propagated upwards along the call chain. This, in turn, causes compensating actions of all previously committed atomic transactions to be evaluated. The monadic return and bind are standard operations for continuation passing style (CPS) computations.

Source Code 7 shows a bank account transfer operation that uses the all-or-nothing monad.

SOURCE CODE 7

```
    credit : Account → float → Atomic<unit>
    let transfer to from amount = allornothing {
        do!
            debit from amount
            | > compensate With < |
            fun ( ) → credit from amount
    return! toAllOrNothing (credit to amount)
}
```

In this transfer operation, a compensating action, creditfrom, is associated with the debitfrom action. The credit is an atomic transaction that may also abort. If credit action aborts after the debit action aborts, the all-or-nothing semantics ensure that the compensating action of debit is evaluated.

Conceptually, the molecular transaction monad is a composition of the failfree monad and the all-or-nothing monad. However, not all monads compose atomic actions 104. In one embodiment, these monads may be condensed into a single monad. In such an embodiment, it may be possible to express the composition directly using monad transformers.

Source Code 8 is an interface of the molecular transaction monad.

SOURCE CODE 8

type Molecule< ′a >
return : ′a → Molecule< ′a >
bind : Molecule< ′a > → ( ′a → Molecule< ′b > ) → Molecule< ′b >
toMolecule : Atomic< ′a > → Molecule< ′a >
compensateWith : Atomic< ′a > → ( ′a → Atomic<unit> ) →
Molecule< ′a >
runMolecule : Molecule< ′a > → (unit → unit) → unit

The runMolecule construct allows the programmer to specify an abort handler, which is called if the molecule aborts. Abort handlers are useful for generic post-processing at the top level, such as registering that the transaction aborted. Examples illustrating the use of this monad appear in Source Code 1 and Source Code 9:

SOURCE CODE 9

```
let createExpenseReport expense = molecule {
    do!
        addAtomic “expensetable” expense.Id expense.Details
        | > compensateWith < |
        fun ( ) → deleteAtomic “expensetable” expense.Id
    return! toMolecule atomic {
        try
            for item in expense.Items do
            return! addAtomic “expenseitemtable” item
        with
        | e → abort( ) }
}
```

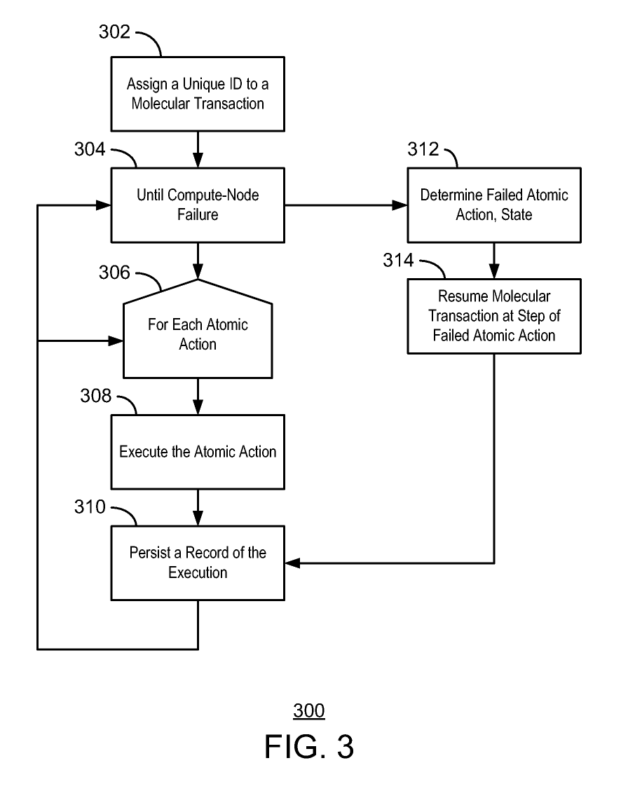

FIG. 3 is a process flow diagram of a method 300 for executing a molecular transaction 102 on a distributed platform, in accordance with the claimed subject matter. The method 300 begins at block 302, where the molecular transaction 102 is assigned a unique identifier called a transaction identifier. Further, every atomic action 104 in the molecular transaction 102 may be assigned a step number. In this way, the transaction identifier, combined with a step number, provides a unique identifier for every atomic action 104 executed. Blocks 304-210 are performed until a compute node fails.

Blocks 306-310 are performed for every successfully executed atomic action 104. All the atomic actions 104 of the transaction may be sequentially composed in a fault-tolerant fashion. This may be achieved by maintaining a worklist of pending work items. Each work item identifies an atomic action 104 to be executed, along with values for any parameters. The parameters may include the unique transaction identifier, the step number, and any data values used to execute the atomic action 104. One or more worker processes 112 may iteratively process the worklist for each transaction. Each worker process 112 extracts a work item from the worklist The worker process 112 performs the atomic action 104, and increments the step number. A new work item is created identifying the next step in the transaction, and added to the worklist. The original work item may then be removed from the worklist. Alternatively, instead of creating new work items after every atomic action 104, execution of subsequent atomic actions 104 may continue, and specific points may be chosen where work items are created and added to the worklist.

At block 308, the atomic action 104 may be executed. At block 310, a record of the successful completion of the atomic action 104 may be persisted. The record may be a tuple stored in a same database as that accessed by the atomic action 104. The tuple may indicate that an instance of the atomic action 104, identified by the transaction identifier and step number, has already executed. As stated previously, blocks 304-210 may be repeated until a compute-node failure occurs.

At block 312, it may be determined which atomic action 104 was executing when the compute-node failed. The state of the molecular transaction 102 at the time of the compute-node failure may also be determined. At block 314, the molecular transaction 102 may resume at the step of the failed atomic action 104. The execution of the atomic action 104 is modified to check if the atomic action 104 has already executed. If it has, then the atomic action 104 is not repeated. Otherwise, the atomic action 104 is executed, and atomically with the same action, a tuple identifying the atomic action 104 instance is persisted to record the execution of the step. In this way, the atomic actions 104 may become idempotent.

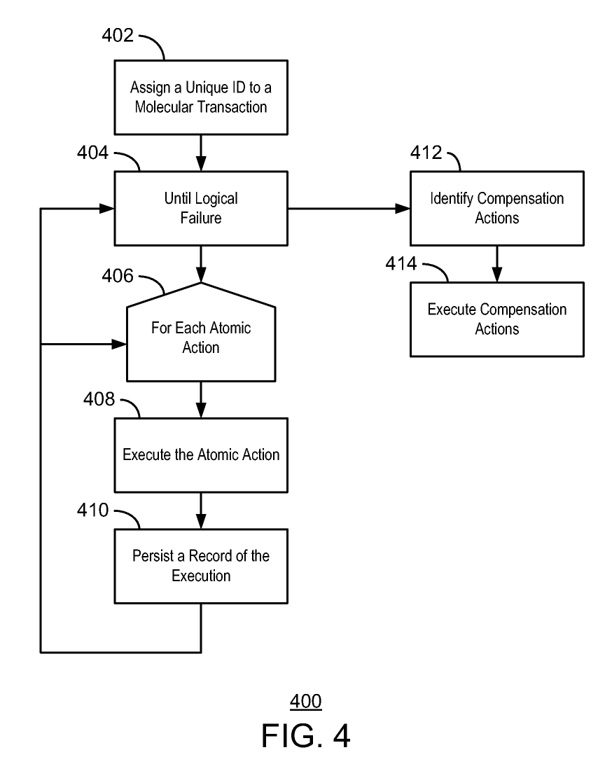

FIG. 4 is a process flow diagram of a method 400 for executing a molecular transaction 102 on a distributed platform, in accordance with the claimed subject matter. The method 400 begins at block 402, where the molecular transaction 102 is assigned a unique identifier called a transaction identifier. Further, every atomic action 104 in the molecular transaction 102 may be assigned a step number. In this way, the transaction identifier, combined with a step number, provides a unique identifier for every atomic action 104 executed. Blocks 404-310 are performed until a logical failure occurs. Blocks 406-310 are performed for every successfully executed atomic action 104. At block 408, the atomic action 104 may be executed. At block 410, a record of the successful completion of the atomic action 104 may be persisted, as described above.

A logical failure may be determined by code in the molecular transaction 102, and may be invoked by a call to the abort construct. At block 412, the compensating actions corresponding to the successfully executed atomic actions 104 may be identified. At block 416, the identified compensation actions 106 may be executed. In one embodiment, these compensating actions may be performed in an order that is the inverse of the original order of the corresponding atomic actions 104.

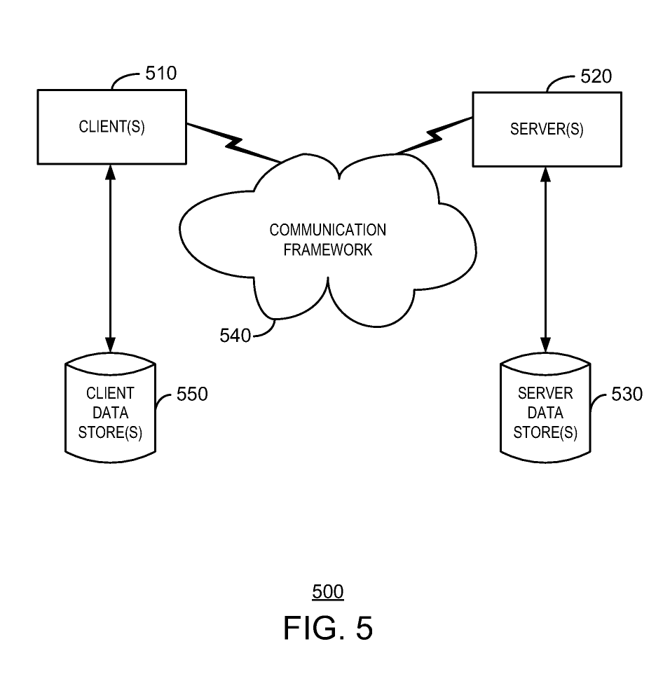

FIG. 5 is a block diagram of an exemplary networking environment 500 wherein aspects of the claimed subject matter can be employed. Moreover, the exemplary networking environment 500 may be used to implement a system and method that executes transactions on a distributed platform, as described herein.

The networking environment 500 includes one or more client(s) 502. The client(s) 502 can be hardware and/or software (e.g., threads, processes, computing devices). As an example, the client(s) 502 may be computers providing access to servers over a communication framework 508, such as the Internet.

The environment 500 also includes one or more server(s) 504. The server(s) 504 can be hardware and/or software (e.g., threads, processes, computing devices). The server(s) 504 may include network storage systems. The server(s) may be accessed by the client(s) 502.

One possible communication between a client 502 and a server 504 can be in the form of a data packet adapted to be transmitted between two or more computer processes. The environment 500 includes a communication framework 508 that can be employed to facilitate communications between the client(s) 502 and the server(s) 504.

The client(s) 502 are operably connected to one or more client data store(s) 510 that can be employed to store information local to the client(s) 502. The client data store(s) 510 may be located in the client(s) 502, or remotely, such as in a cloud server. Similarly, the server(s) 504 are operably connected to one or more server data store(s) 506 that can be employed to store information local to the servers 504.

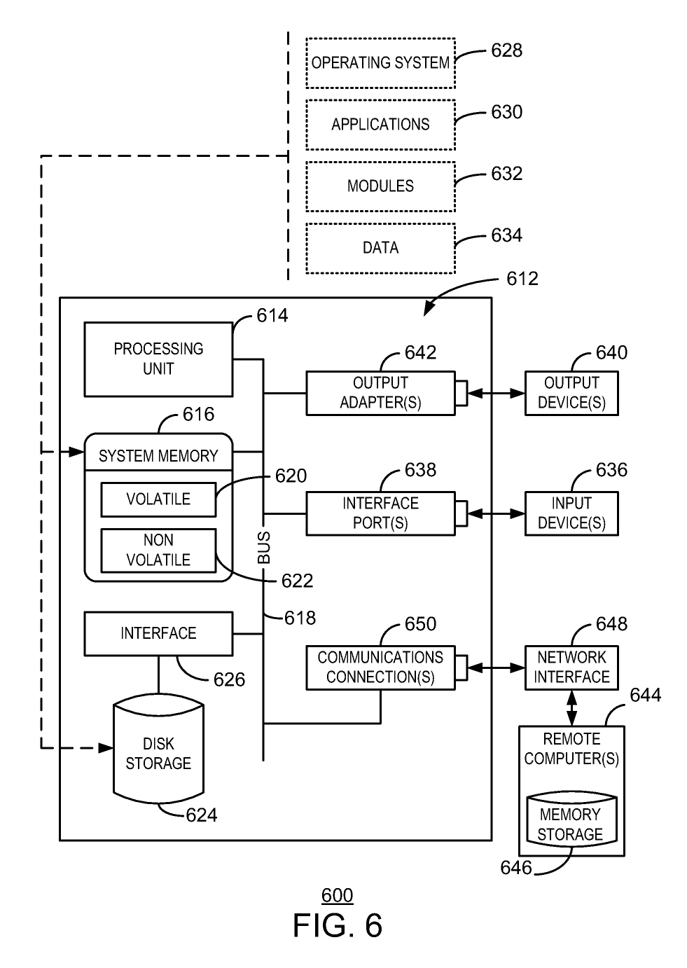

With reference to FIG. 6, an exemplary operating environment 600 is shown for implementing various aspects of the claimed subject matter. The exemplary operating environment 600 includes a computer 612. The computer 612 includes a processing unit 614, a system memory 616, and a system bus 618. In the context of the claimed subject matter, the computer 612 may be configured to execute transactions on distributed platforms.

The system bus 618 couples system components including, but not limited to, the system memory 616 to the processing unit 614. The processing unit 614 can be any of various available processors. Dual microprocessors and other multiprocessor architectures also can be employed as the processing unit 614.

The system bus 618 can be any of several types of bus structure(s) including the memory bus or memory controller, a peripheral bus or external bus, and/or a local bus using any variety of available bus architectures known to those of ordinary skill in the art. The system memory 616 comprises non-transitory computer-readable storage media that includes volatile memory 620 and nonvolatile memory 622.

The basic input/output system (BIOS), containing the basic routines to transfer information between elements within the computer 612, such as during start-up, is stored in nonvolatile memory 622. By way of illustration, and not limitation, nonvolatile memory 622 can include read only memory (ROM), programmable ROM (PROM), electrically programmable ROM (EPROM), electrically erasable programmable ROM (EEPROM), or flash memory.

Volatile memory 620 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 612 also includes other non-transitory computer-readable media, such as removable/non-removable, volatile/non-volatile computer storage media. FIG. 6 shows, for example a disk storage 624. Disk storage 624 includes, but is not limited to, devices like a magnetic disk drive, floppy disk drive, tape drive, Jaz drive, Zip drive, LS-100 drive, flash memory card, or memory stick.

In addition, disk storage 624 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 624 to the system bus 618, a removable or non-removable interface is typically used such as interface 626.

It is to be appreciated that FIG. 6 describes software that acts as an intermediary between users and the basic computer resources described in the suitable operating environment 600. Such software includes an operating system 628. Operating system 628, which can be stored on disk storage 624, acts to control and allocate resources of the computer system 612.

System applications 630 take advantage of the management of resources by operating system 628 through program modules 632 and program data 634 stored either in system memory 616 or on disk storage 624. It is to be appreciated that the claimed subject matter can be implemented with various operating systems or combinations of operating systems.

A user enters commands or information into the computer 612 through input device(s) 636. Input devices 636 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 636 connect to the processing unit 614 through the system bus 618 via interface port(s) 638. Interface port(s) 638 include, for example, a serial port, a parallel port, a game port, and a universal serial bus (USB).

Output device(s) 640 use some of the same type of ports as input device(s) 636. Thus, for example, a USB port may be used to provide input to the computer 612, and to output information from computer 612 to an output device 640.

Output adapter 642 is provided to illustrate that there are some output devices 640 like monitors, speakers, and printers, among other output devices 640, which are accessible via adapters. The output adapters 642 include, by way of illustration and not limitation, video and sound cards that provide a means of connection between the output device 640 and the system bus 618. It can be noted that other devices and/or systems of devices provide both input and output capabilities such as remote computer(s) 644.

The computer 612 can be a server hosting various software applications in a networked environment using logical connections to one or more remote computers, such as remote computer(s) 644. The remote computer(s) 644 may be client systems configured with web browsers, PC applications, mobile phone applications, and the like.

The remote computer(s) 644 can be a personal computer, a server, a router, a network PC, a workstation, a microprocessor based appliance, a mobile phone, a peer device or other common network node and the like, and typically includes many or all of the elements described relative to the computer 612.

For purposes of brevity, only a memory storage device 646 is illustrated with remote computer(s) 644. Remote computer(s) 644 is logically connected to the computer 612 through a network interface 648 and then physically connected via a communication connection 650.

Network interface 648 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 650 refers to the hardware/software employed to connect the network interface 648 to the bus 618. While communication connection 650 is shown for illustrative clarity inside computer 612, it can also be external to the computer 612. The hardware/software for connection to the network interface 648 may include, for exemplary purposes only, internal and external technologies such as, mobile phone switches, modems including regular telephone grade modems, cable modems and DSL modems, ISDN adapters, and Ethernet cards.

An exemplary processing unit 614 for the server may be a computing cluster comprising Intel® Xeon CPUs. The disk storage 624 may comprise an enterprise data storage system, for example, holding thousands of impressions.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for executing molecular transactions on a distributed platform, comprising:
generating a first unique identifier for an execution of a molecular transaction comprising a first atomic action;
persisting a first work list record comprising the first unique identifier and a step number for the first atomic action;
retrieving, by a first worker process of a runtime, the first work list record;
executing, by the first worker process, the first atomic action in response to determining that a first successful completion record for the first atomic action does not exist; and
persisting, by the first worker process, the first successful completion record for the first atomic action in response to a successful execution of the first atomic action.

2. The method recited in claim 1, comprising persisting, by the first worker process, a second work list record comprising the unique identifier and a step number for a second atomic action, wherein the molecular transaction comprises the second atomic action, and wherein the molecular transaction specifies that the second atomic action is executed subsequently to the first atomic action.

3. The method recited in claim 2, comprising deleting, by the first worker process, the first work list record.

4. The method recited in claim 3, wherein the molecular transaction comprises a first compensation action corresponding to the first atomic action.

5. The method recited in claim 4, comprising:
retrieving, by a second worker process of the runtime, the second work list record;
executing, by the second worker process, the second atomic action in response to determining that a successful completion record for the second atomic action does not exist;
aborting the molecular transaction during execution of the second atomic action;
persisting, by the second worker process, a second successful completion record for the second atomic action such that the second successful completion record comprises a status indicating the molecular transaction is aborting;
persisting, by the second worker process, a third work list record comprising the unique identifier and a step number for the first compensation action;
retrieving, by a third worker process of the runtime, the third work list record;
executing, by the third worker process, the first compensation action in response to determining that a successful completion record for the first compensation action does not exist; and
persisting, by the third worker process, the successful completion record for the first compensation action in response to a successful execution of the first compensation action.

6. The method recited in claim 3, comprising:
retrieving, by a second worker process of the runtime, the second work list record;
executing, by the second worker process, the second atomic action in response to determining that a successful completion record for the second atomic action does not exist; and
persisting, by the second worker process, the successful completion record for the second atomic action in response to a successful execution of the second atomic action.

7. The method recited in claim 6, comprising deleting, by the second worker process, the second work list record.

8. The method recited in claim 1, comprising:
determining that the first worker process has failed in executing the first atomic action; and
replacing the first worker process with a replacement worker process that:
retrieves the first work list record;
executes the first atomic action in response to determining that a successful completion record for the first atomic action does not exist; and
persists the successful completion record for the first atomic action in response to a successful execution of the first atomic action.

9. A system for executing a transaction on a distributed platform, comprising:
a processing unit; and
a system memory, wherein the system memory comprises code configured to direct the processing unit to:
generate a first unique identifier for an execution of a molecular transaction comprising a first atomic action;
persist a first work list record comprising the first unique identifier and a step number for the first atomic action;
retrieve the first work list record;
execute the first atomic action in response to a determination that a first successful completion record for the first atomic action does not exist;
determine that a first worker process has failed to successfully execute the first atomic action; and
replace the first worker process with a replacement worker process.

10. The system recited in claim 9, wherein the replacement worker process is configured to:
retrieve the first work list record;
execute the first atomic action in response to determining that a successful completion record for the first atomic action does not exist; and
persist the successful completion record for the first atomic action in response to a successful execution of the first atomic action.

11. The system recited in claim 10, comprising code configured to direct the processing unit to persist a second work list record comprising the unique identifier and a step number for a second atomic action, wherein the molecular transaction comprises the second atomic action, and wherein the molecular transaction specifies that the second atomic action is executed subsequently to the first atomic action.

12. The system recited in claim 11, comprising code configured to direct the processing unit to delete the first work list record.

13. The system recited in claim 12, wherein the molecular transaction comprises a first compensation action corresponding to the first atomic action.

14. The system recited in claim 13, comprising code configured to direct the processing unit to:
retrieve the second work list record;
execute the second atomic action in response to a determination that a successful completion record for the second atomic action does not exist;
abort the molecular transaction during execution of the second atomic action;
persist a second successful completion record for the second atomic action such that the second successful completion record comprises a status indicating the molecular transaction is aborting;
persist a third work list record comprising the unique identifier and a step number for the first compensation action;
retrieve the third work list record;
execute the first compensation action in response to a determination that a successful completion record for the first compensation action does not exist; and
persist the successful completion record for the first compensation action in response to a successful execution of the first compensation action.

15. The system recited in claim 12, comprising code configured to direct the processing unit to:
retrieve the second work list record;
execute the second atomic action in response to a determination that a successful completion record for the second atomic action does not exist; and
persist the successful completion record for the second atomic action in response to a successful execution of the second atomic action.

16. The system recited in claim 15, comprising code configured to direct the processing unit to delete the second work list record.

17. One or more computer-readable storage media, comprising code configured to direct a processing unit to:
generate a first unique identifier for an execution of a molecular transaction comprising a first atomic action and a second atomic action, wherein the molecular transaction specifies that the second atomic action is executed subsequently to the first atomic action;
persist a first work list record comprising the first unique identifier and a step number for the first atomic action;
retrieve the first work list record;
execute the first atomic action in response to a determination that a first successful completion record for the first atomic action does not exist;
persist the first successful completion record for the first atomic action in response to a successful execution of the first atomic action;
persist a second work list record comprising the unique identifier and a step number for the second atomic action;
retrieve the second work list record;
execute the second atomic action in response to a determination that a successful completion record for the second atomic action does not exist;
abort the molecular transaction during execution of the second atomic action, wherein the molecular transaction comprises a first compensation action corresponding to the first atomic action;
persist a second successful completion record for the second atomic action such that the second successful completion record comprises a status indicating the molecular transaction is aborting; and
persist a third work list record comprising the unique identifier and a step number for the first compensation action.

18. The one or more computer-readable storage media recited in claim 17, comprising code configured to direct the processing unit to:
retrieve the third work list record;
execute the first compensation action in response to a determination that a successful completion record for the first compensation action does not exist; and
persist the successful completion record for the first compensation action in response to a successful execution of the first compensation action.

19. The one or more computer-readable storage media recited in claim 17, comprising code configured to direct the processing unit to delete the first work list record.

20. The one or more computer-readable storage media recited in claim 17, comprising
code configured to direct the processing unit to delete the second work list record.
